(19) United States
(12) Patent Application Publication
(10) Pub. No.: US 2024/0403904 A1
(43) Pub. Date: Dec. 5, 2024

(54) Obtaining Actionable Application Feedback via Generation of LLM-Based Survey Prompts and Application Insights

(71) Applicant: Microsoft Technology Licensing, LLC, Redmond, WA (US)

(72) Inventors: David Benjamin LEVITAN, Bothell, WA (US); Ishita SHARMA, Sammamish, WA (US); RajeshKumar KOMMU, Redmond, WA (US); Joshua Michael DUNNING, Denver, CO (US); Seyedeh Hoda SHAJARI, Gainesville, FL (US); Julia S. MCANALLEN, Seattle, WA (US)

(21) Appl. No.: 18/325,561

(22) Filed: May 30, 2023

(51) Int. Cl. G06Q 30/0203

(52) U.S. Cl. CPC G06Q 30/0203

(57) ABSTRACT

A computer-implemented method for obtaining actionable application feedback includes executing an application on remote computing systems and, during execution of the application on each computing system: surfacing a UI including a survey UI element on the display of the computing system; surfacing a first survey prompt via the survey UI element; receiving user input including a response to the first survey prompt, inputting the user input to an LLM; generating, via the LLM, a second survey prompt based on the provided user input; surfacing the second survey prompt via the survey UI element; receiving user input including a verbatim response to the second survey prompt; and generating, via the LLM, topic tag(s) corresponding to the verbatim response. The method includes aggregating the verbatim responses received via the computing systems according to the corresponding topic tag(s), as well as generating, via the LLM, application insights based on the aggregated verbatim responses.

### BACKGROUND

The present disclosure generally relates to the collection of application feedback from users. More specifically, the present disclosure relates to obtaining actionable application feedback from users via large language model (LLM)-based survey prompt generation and LLM-based application insights generation.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an embodiment, a method for obtaining actionable application feedback from users is described. The method is implemented via a computing system including a processor. The method includes causing the execution of an application on multiple remote computing systems and (during the execution of the application on each of the remote computing systems) causing the surfacing of a user interface on the display of the remote computing system, where the user interface includes a survey user interface element. The method also include (during the execution of the application on each of the remote computing systems) causing the surfacing of a first survey prompt via the survey user interface element of the user interface, receiving, via the survey user interface element of the user interface, a first user input including a response to the first survey prompt, and inputting the first user input to a large language model (LLM). The method further includes (during the execution of the application on each of the remote computing systems) generating, via the LLM, a second survey prompt based on the provided first user input, causing the surfacing of the second survey prompt via the survey user interface element of the user interface, receiving, via the survey user interface element of the user interface, a second user input including a verbatim response to the second survey prompt, and generating, via the LLM, one or more topic tags corresponding to the verbatim response. The method also includes aggregating the verbatim responses received during the execution of the application on all the remote computing systems, where the verbatim responses are aggregated according to the topic tag(s) corresponding to each verbatim response, as well as generating, via the LLM, application insights corresponding to the application based on the aggregated verbatim responses, where the application insights include one or more metrics relating to application performance, application usage, subscription value, and/or user satisfaction with respect to the application.

In another embodiment described herein, an application service provider server is provided. The application service provider server includes a processor, an application, a communication connection for connecting remote computing systems to the application service provider server via a network, and a computer-readable storage medium operatively coupled to the processor. The computer-readable storage medium includes computer-executable instructions that, when executed by the processor, cause the processor to cause the execution of the application on the remote computing systems and (during the execution of the application on each of the remote computing systems) to cause the surfacing of a user interface on the display of the remote computing system, where the user interface includes a survey user interface element. The computer-readable storage medium also includes computer-executable instructions that, when executed by the processor, cause the processor (during the execution of the application on each of the remote computing systems) to cause the surfacing of a first survey prompt via the survey user interface element of the user interface, to receive, via the survey user interface element of the user interface, a first user input including a response to the first survey prompt, to input the first user input to an LLM and to generate, via the LLM, a second survey prompt based on the provided first user input. The computer-readable storage medium also includes computer-executable instructions that, when executed by the processor, cause the processor (during the execution of the application on each of the remote computing systems) to cause the surfacing of the second survey prompt via the survey user interface element of the user interface, to receive, via the survey user interface element of the user interface, a second user input including a verbatim response to the second survey prompt, and to generate, via the LLM, one or more topic tags corresponding to the verbatim response. The computer-readable storage medium further includes computer-executable instructions that, when executed by the processor, cause the processor to aggregate the verbatim responses received during the execution of the application on all the remote computing systems, where the verbatim responses are aggregated according to the topic tag(s) corresponding to each verbatim response, as well as to generate, via the LLM, application insights corresponding to the application based on the aggregated verbatim responses, where the application insights include one or more metrics relating to application performance, application usage, subscription value, and/or user satisfaction with respect to the application.

In another embodiment described herein, a computer-readable storage medium is provided. The computer-readable storage medium includes computer-executable instructions that, when executed by a processor, cause the processor to cause the execution of an application on multiple remote computing systems and (during the execution of the application on each of the remote computing systems) to cause the surfacing of a user interface on a display of the remote computing system, wherein the user interface includes a survey user interface element. The computer-readable storage medium also includes computer-executable instructions that, when executed by the processor, cause the processor (during the execution of the application on each of the remote computing systems) to cause the surfacing of a first survey prompt via the survey user interface element of the user interface, to receive, via the survey user interface element of the user interface, a first user input including a response to the first survey prompt, to input the first user input and user-specific data to an LLM, and to generate, via the LLM, a second survey prompt based on the provided first user input and the user-specific data. The computer-readable storage medium also includes computer-executable instructions that, when executed by the processor, cause the processor (during the execution of the application on each of the remote computing systems) to cause the surfacing of the second survey prompt via the survey user interface element of the user interface, to receive, via the survey user interface element of the user interface, a second user input including a verbatim response to the second survey prompt, and to generate, via the LLM, one or more topic tags corresponding to the verbatim response. The computer-readable storage medium further includes computer-executable instructions that, when executed by the processor, cause the processor to aggregate the verbatim responses received during the execution of the application on all the remote computing systems, where the verbatim responses are aggregated according to the topic tag(s) corresponding to each verbatim response, as well as to generate, via the LLM, application insights corresponding to the application based on the aggregated verbatim responses, where the application insights include one or more metrics relating to application performance, application usage, subscription value, and/or user satisfaction with respect to the application.

### BRIEF DESCRIPTION OF THE DRAWINGS

The following detailed description may be better understood by referencing the accompanying drawings, which contain specific examples of numerous features of the disclosed subject matter.

FIG. 1 is a process flow diagram of an exemplary method for obtaining actionable application feedback from users via large language model (LLM)-based survey prompt generation and LLM-based application insights generation according to embodiments described herein;

FIGS. 2A, 2B, 2C, and 2D are simplified schematic views of an exemplary user interface for implementing at least a portion of the techniques described herein;

FIG. 3 is a process flow diagram of another exemplary method for obtaining actionable application feedback from users via LLM-based survey prompt generation and LLM-based application insights generation according to embodiments described herein;

FIG. 4 is a block diagram of an exemplary computing system for implementing the techniques described herein;

FIG. 5 is a block diagram of an exemplary network environment for implementing the techniques described herein; and

FIG. 6 is a block diagram of an exemplary computer-readable storage medium for implementing the techniques described herein.

### DETAILED DESCRIPTION

Application service providers frequently collect user feedback in order to obtain both a general view of the users' opinions about the corresponding applications as well as more specific information about the particular aspects of the applications that the users like or dislike. This user feedback is then utilized to steer the direction of application updates and/or the development of future applications. Moreover, in general, user feedback is collected in an automated, electronic format, such as via prompts provided during the execution of the corresponding application. Such prompts often include a rating-based prompt, such as a net promoter score (NPS) prompt, in which the user is first asked to provide a numeric rating of the application using a prompt such as “Would you recommend this product to a friend or colleague?” Once the user provides the numeric rating, the application might provide a generic, pre-generated survey prompt, such as “Why or why not?” This survey prompt is designed to enable the user to provide verbatim (i.e., free text) feedback in addition to the numeric rating. However, because the survey prompt is very generic and not customized to the user, the verbatim response provided by the user is also typically generic and, thus, not highly useful to the application service provider. As an example, while the user might believe that stating “It's slow” or “It's too hard to use” is helpful, such feedback provides too little information to be actionable. In contrast, feedback such as “It's very slow to load my file” or “I can't find the Import Data button” is substantially more useful to the application service provider, providing enough information to be actionable in terms of application updates. Furthermore, this type of specific, actionable feedback could be used to drive product investments, to inform the long-term strategy for building state-of-the-art applications, to provide a basis for prioritizing application updates, and/or to develop application insights (e.g., in the form of an application insights report) including relevant business metrics, such as the overall NPS for a particular application.

Accordingly, the present techniques relate to an end-to-end survey process that provides for the generation of large language model (LLM)-based survey prompts and LLM-based application insights. More specifically, according to embodiments described herein, survey prompts are dynamically generated using an LLM, such as a generative pretrained transformer model. In particular, the LLM is trained to dynamically generate specific, targeted survey prompts based on the real-time data input by the user, including, for example, verbatim feedback provided by the user. Moreover, according to embodiments described herein, the user's personalized data and/or prior survey response(s) may also be provided as input to the LLM during the survey prompt generation process, thus ensuring that the resulting survey prompts are specifically geared toward obtaining actionable application feedback from the particular user. As an example, if the user provides initial verbatim feedback of “It's too slow,” the LLM may be utilized to generate a follow-up survey prompt such as “I understand how frustrating that can be. Can you tell us more about what part of the application is slow? Are there any specific tasks you are trying to do that are taking a long time?” As another example, if the user provides initial verbatim feedback of “I love it,” the LLM may be utilized to generate a follow-up survey prompt such as “Thank you for the positive feedback! Can you please explain what you like most about this application?” In both cases, the generated survey prompts are suggestive of details that would be useful for the application service provider, providing the user with effective guidance for providing an actionable response.

In addition, according to embodiments described herein, the LLM is utilized to classify the dynamically-generated survey prompts and the verbatim responses from users, as well as to generate topic tags corresponding to one or more topics identified within each survey prompt and each verbatim response (and/or within each prompt/response pair). In various embodiments, this is accomplished via prompt engineering and/or model fine tuning. Such topic tags are then treated as meta-information that is used internally by the application service provider during post processing. More specifically, because the survey prompts are personalized to each user, prompts that are related to a single topic may include a range of different terminologies, and the resulting verbatim responses from the users may also include a range of different terminologies. As a result, the heterogeneous prompt/response pairs are difficult to analyze. Therefore, associating particular topic tags with the prompts and responses (and/or the prompt-response pairs) provides a reference point for comparing similar feedback collected across different survey instances. Such comparisons may be used for general data collection purposes and/or for the generation of application insights. Moreover, in some embodiments, the topic tags include a predefined set of topics. Additionally or alternatively, in some embodiments, the topic tags include new topics that are generated on the fly as emerging issues arise within the user feedback.

Furthermore, according to embodiments described herein, the feedback data received from the users and the topic tag metadata generated by the LLM are fed into an insights tool, such as, for example, the Sensei tool, resulting in the generation of application insights relating to the collected feedback (e.g., typically in the form of an application insights report), where the term “application insights” is used herein to refer to one or more metrics relating to application performance, application usage, subscription value, and/or user satisfaction with respect to the application. More specifically, the verbatim responses received from the users are first aggregated by grouping the responses according to the topic tags generated by the LLM. Additional insights analysis is then performed by leveraging clustering and/or topic modeling, such as, for example, Latent Dirichlet Allocation (LDA) or Hierarchical Density-Based Spatial Clustering of Applications with Noise (HDBSCAN), to associate sub-topics (e.g., in the form of sub-topic tags) with the responses. In particular, after grouping the topic tags, there may still be significant variety in the verbatim responses corresponding to each topic tag. As a result, clustering and/or topic modeling may be performed to further differentiate between specific sub-topics corresponding to the broader topics. As an example, a topic tag titled “Subscription Value” may be broken down into several sub-topic tags, such as “Cost of Subscription,” “Ease of Renewal Process,” and “Value Compared to Competitor Products.” In various embodiments, the generation of such sub-topics is utilized as a basis to provide a more refined, customized application insights report to the application service provider, enabling the application service provider to determine which aspects of the application would benefit from updates, for example. Moreover, additional text analytics and metrics, such as, for example, NPS, user sentiment, verbatim share (i.e., the volume of feedback clustered together), actionability score, NPS drag, date, product, and/or region, may also be applied to the aggregated and/or clustered feedback to track the health and trends of the corresponding applications, and such information may also be included within the application insights report. For example, the application insights report may include information relating to the feedback volume, overall customer sentiment, overall text quality, and/or overall actionability score for the application. Furthermore, the application insights report may track other key metrics relating to the relevant application, including, for example, the overall NPS for the application, as well as provide information regarding areas for product improvement. In some cases, goals and/or targets may also be determined or suggested based on the tracked key metrics.

In various embodiments, the LLM is further utilized to generate a resource tag for the collected verbatim response(s) from each user, where such resource tag indicates one or more resources that may be of interest to the user, as identified by the LLM. For example, the LLM may utilize the feedback data received from the user, optionally in combination with other data corresponding to the user, to determine one or more help or support solutions (e.g., in-application services, third-party services, websites, or the like) that are likely to be useful to the user in solving issues that were indicated in the feedback data. Such resources may then be provided to the user in real-time (e.g., via surfacing of the resources on the user interface immediately after the user provides the corresponding feedback or, alternatively, upon completion of the overall survey) and/or may be provided to the user via email, for example.

In some embodiments, the resource tag(s) are generated according to a keyword-based approach and/or a semantic search approach. For example, if a semantic search approach is utilized, sentence embeddings may be generated for the verbatim responses, and then each sentence embedding may be matched (e.g., to the closest matches that are below some threshold, according to a cosine similarity score or similar measure) with sentence embeddings corresponding to the potential resources.

In some embodiments, the resulting verbatim feedback obtained from the user is assigned an actionability score. This actionability score may be binary (e.g., actionable or non-actionable), contain greater than two categories (e.g., not actionable, somewhat actionable, moderately actionable, or very actionable), or even be a continuous numeric value (e.g., any real number between 0 and 1). Moreover, the actionability score may be determined in any suitable manner. For example, in some embodiments, the actionability score is determined using a rule-based method (e.g., by counting the number of words in the verbatim response or counting the percentage of dictionary-recognizable words in the verbatim response). In other embodiments, the actionability score is determined by training a supervised machine learning classifier on this task with labeled data. In yet other embodiments, the LLM is utilized to determine the actionability score; for example, when the LLM assigns topic tag(s) to the verbatim response, it may also assign an actionability score to the verbatim response. Furthermore, in some embodiments, the determined actionability score is aggregated with actionability scores obtained from other survey instances, and the resulting overall actionability score for the application feedback may be included within the application insights report, for example.

The present techniques provide various advantages over conventional survey technology. As an example, the present techniques provide an end-to-end survey system from data collection to application insights, unlocking the functionality of dynamic survey prompt generation based on personalized user data and previous user responses, specifically by leveraging the capabilities of LLMs. In contrast, conventional surveys provide static, pre-generated survey prompts that are generic and not highly engaging. As another example, the present techniques provide for the classification and tagging of the dynamically-generated survey prompts, enabling a large number of survey prompts including a range of different personalized terminologies to be correlated based on the overall topics or themes. As another example, because the present techniques rely on machine learning techniques, the survey prompts are generated in real-time (or near real-time) as the user provides verbatim feedback, thus increasing the extent to which the survey prompts can be customized to the user's specific input. As another example, because an LLM is utilized to generate the survey prompts according to the present techniques, the survey prompts may be automatically varied from very broad (e.g., “We don't quite understand what you mean. Can you rephrase your response?”) to very specific (e.g., “What part of moving cells is difficult?”) based on the specific context and data corresponding to the user. This makes the user feel heard, makes the user more likely to provide a detailed, actionable response, and provides a platform to optionally provide resources (e.g., help or support solutions) for any issues the user is experiencing. As another example, the present techniques provide an end-to-end survey pipeline that utilizes LLM capabilities for both survey prompt generation and corresponding application insights generation, thus providing for the effective extraction of meaningful and actionable application insights from feedback data. As a result, the present techniques serve to improve the actionability of the collected feedback (thus facilitating accelerated product improvements), as well as to reduce the amount of time and effort needed to extract application insights from such feedback.

Furthermore, as another example, the present techniques provide significant advantages over conventional chatbot approaches. First, according to the present techniques, the survey interaction is embedded within a feedback collection tool, so it is not a traditional chatbot. Second, conventional chatbot interactions must be handled as free text dialogue without the possibility of rapid insights generation resulting from the interaction. In contrast, the present techniques close these gaps by generating a more dynamic experience for users, while also offering a more robust system for cataloguing and analyzing user feedback to speed up product improvements and insights. Third, while conventional chatbots are provided as tools that are distinct from the underlying application or service, the survey system provided by the present techniques is fully integrated into the existing application such that the survey process is streamlined from user's perspective and, thus, requires minimal time or effort.

As used herein, the term “application” refers to any suitable type(s) of web-based application(s), mobile application(s), operating system(s), and/or other application(s) that are provided by an application service provider. In various embodiments, the term “application” is used herein with reference to an enterprise application that forms part of a suite or package of products/services (or some subset of such suite/package) that is provided by the application service provider to enable users who are associated with an enterprise to interact with their corresponding computing systems to perform tasks relating to the enterprise. As a non-limiting example, if the application service provider is Microsoft Corporation, the application(s) described herein may include (but are not limited to) any or all of the applications within the Microsoft 365® suite. Such applications include Microsoft® Viva®, Microsoft® Excel®, Microsoft® Word®, Microsoft® Teams®, Microsoft® PowerPoint®, Microsoft® Outlook®, Microsoft® OneNote®, Microsoft® OneDrive®, and Microsoft® SharePoint® (among others). As another non-limiting example, if the application service provider is Microsoft Corporation, the application(s) described herein may include (but are not limited to) the Microsoft® Windows® operating system (e.g., Windows 11®). As another non-limiting example, if the application service provider is Microsoft Corporation, the application(s) described herein may include (but are not limited to) to the Admin Center associated with the Microsoft 365® suite (and/or any other administration services associated with any other Microsoft products). More generalized examples of suitable application(s) include (but are not limited to) email/communication applications, social networking applications, employee experience applications, calendar applications, word processing applications, spreadsheet applications, presentation applications, and the like. In other words, the techniques described herein may be implemented within the context of a broad range of web-based applications, mobile applications, operating systems, and/or additional applications/services, especially those that are utilized for enterprise-related tasks.

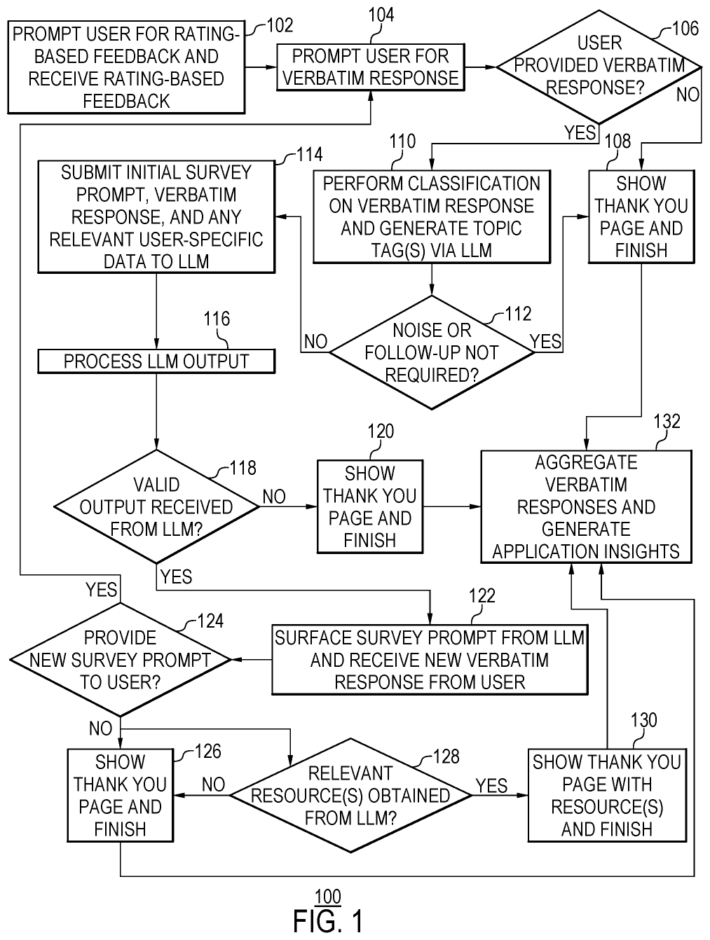

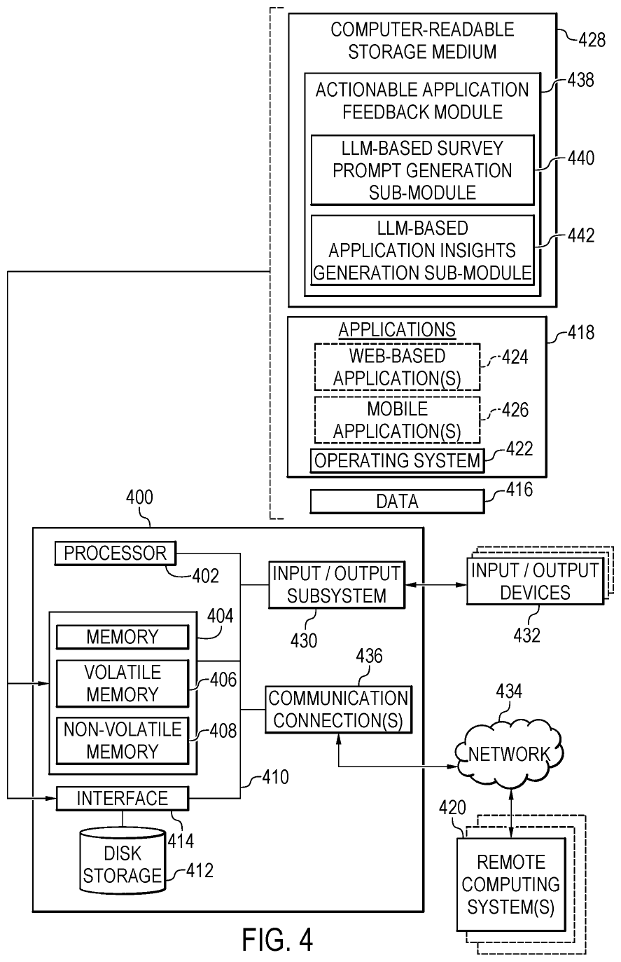

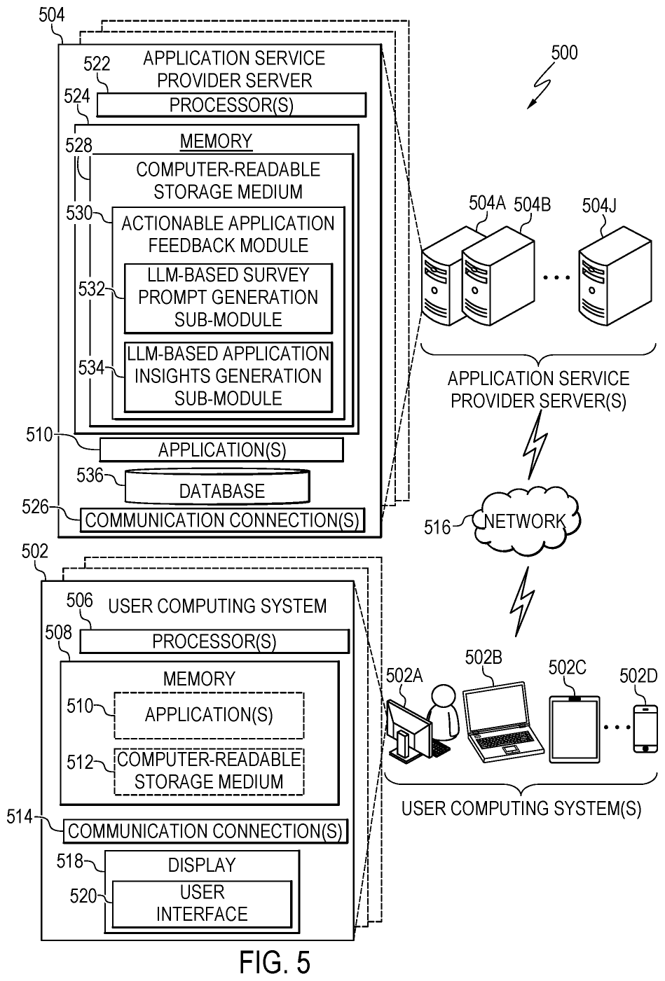

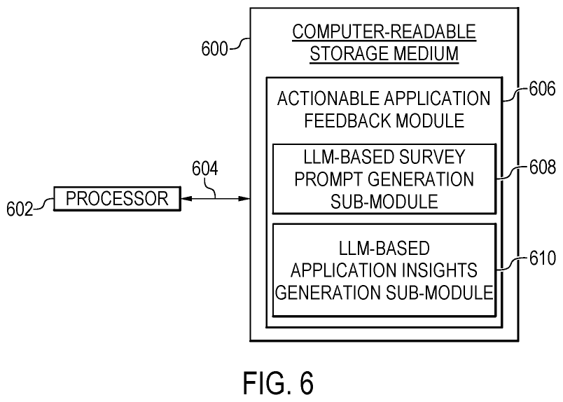

Turning now to a detailed description of the drawings, FIG. 1 is a process flow diagram of an exemplary method 100 for obtaining actionable application feedback from users via LLM-based survey prompt generation and LLM-based application insights generation according to embodiments described herein. The method 100 is executed via one or more computing systems, such as the exemplary computing system described with respect to FIG. 4. In particular, in various embodiments, the computing system(s) implementing the method 100 include one or more computing system(s) or server(s) that are run by an application service provider that provides for the execution of one or more applications on remote user computing systems. The computing system(s)/server(s) include one or more processors and one or more computer-readable storage media including computer-executable instructions that, when executed by the processor(s), cause the processor(s) to perform the blocks of the method 100. An exemplary embodiment of such computer-readable storage media is described with respect to FIG. 6. Moreover, in various embodiments, the method 100 is executed within the context of a network environment including one or more application service provider computing system(s)/server(s), as described further with respect to the exemplary network environment of FIG. 5.

The method 100 is performed during the execution of an application on the user computing system and is facilitated via the surfacing of a user interface on a display corresponding to the user computing system. Moreover, the method 100 corresponds to a survey that is initiated by the application, either automatically or in response to some type of input by the user.

Turning now to the details of the method 100, beginning at block 102, the user is prompted (via the surfaced user interface) for rating-based feedback, and such rating-based feedback is received (also via the user interface). At block 104, the user is then prompted (via the user interface) for a verbatim response. In various embodiments, this is accomplished by surfacing a survey prompt on the user interface, where such survey prompt may be based (at least in part) on the initial rating-based feedback provided by the user at block 102. At block 106, it is determined whether the user provided a verbatim response via the user interface. If the user did not provide the requested verbatim response, the method 100 terminates at block 108 with the surfacing of a “Thank You” page or some other type of page indicating that the survey is complete.

If the user did provide the requested verbatim response, the method 100 continues to block 110, at which classification is performed on the verbatim response via the LLM to determine whether the verbatim response is noise and/or does not require follow-up for some other reason (as described further with respect to block 112), and one or more topic tag(s) are generated for the verbatim response (and/or any combination of the verbatim response, the survey prompt, and the previous response(s) received from the user, depending on the details of the particular implementation) via the LLM. Such topic tag(s) may be obtained from a predefined set of topics and/or may include one or more new topics that are generated on the fly as emerging issues arise within the collected feedback. Examples of such topic tag(s) include (but are not limited to): (1) navigation (e.g., comments on the difficulty of finding elements within the application or navigating the application in general); (2) collaboration (e.g., comments related to the ease or difficulty of working with others using the application); (3) file sharing; (4) document co-editing; (5) competition (e.g., comments comparing the application to a similar application by a competitor); (6) comparison (e.g., comments comparing a feature of the application to a similar feature of another application); (7) missing features; (8) subscription value (e.g., comments related to the perceived value of the application); (9) cost; (10) speed; (11) reliability (e.g., issues with the application not behaving as expected or crashing unexpectedly, potentially including specific bugs/issues with the application and suggestions for correcting such bugs/issues); (12) change management (e.g., customer issues or comments related to application updates; and/or (13) complexity (e.g., comments related to the ease or difficulty of using the application). In various embodiments, such topic tags may generally fall under the categories of application performance, application usage, subscription value, or user satisfaction, or some combination thereof. Moreover, those skilled in the art will appreciate that any number of other topic tags relating to such categories (and/or any other suitable categories) may additionally or alternatively be utilized, depending on the details of the particular implementation.

At block 112, the output from block 110 (including, in particular, the classification of the verbatim response) is utilized to determine if the verbatim response provided by the user constitutes noise (in which case no follow-up is justified) or if follow-up is not required for some other reason. As an example, if the verbatim response includes offensive content, it may be classified as noise and/or as a response that does not require follow-up. As another example, if the user has already provided very detailed verbatim feedback, the response may be classified as a response that does not require follow-up. As another example, positive feedback may be treated differently from negative feedback, and follow-up may not be required (or may not be required as frequently) for one or the other, thus affecting the classification of the corresponding responses. As another example, if the verbatim response is effectively gibberish, it may be classified as noise. As another example, if the verbatim response is random or unrelated to the survey prompt, it may be classified as noise.

If it is determined that the verbatim response has been classified as noise and/or as a response that does not require follow-up at blocks 110 and 112, the method 100 terminates at block 108. Otherwise, the method 100 proceeds to block 114, at which the initial survey prompt data, verbatim response data, and (optionally) any relevant user-specific data are provided to the LLM as input. Such user-specific data may include, but are not limited to, data relating to the customer type (e.g., commercial versus consumer), user license, application/product, platform, existing known issues, device type, and/or tenant-specific information.

At block 116, the resulting output from the LLM is processed. In various embodiments, this includes applying machine-learning and/or rule-based classifiers to the LLM output to guarantee that the survey prompt generated by the LLM is not offensive or irrelevant to the user. As an example, a rule-based classification process may be used to compare the generated survey prompt to a guard-list of predetermined offensive vocabulary to filter out LLM outputs that contain any such offensive words/phrases. As another example, an entailment classification process may be used to compare the LLM output to the original verbatim response received by the user and to ensure that the survey prompt generated by the LLM is relevant. In general, this processing is utilized as a gatekeeping step to make sure that only high-quality LLM outputs are provided to users.

At block 118, it is determined whether a valid output was received from the LLM, i.e., based on the processing performed at block 116. If no valid LLM output was received, the method 100 terminates at block 120. However, if a valid LLM output was received, the method 100 proceeds to block 122.

At block 122, the survey prompt from the LLM is provided to the user via the user interface, and a new verbatim response is received from the user. At block 124, the LLM is utilized to analyze the received response to determine whether a new survey prompt should be shown to the user (e.g., based, at least in part, on comparisons between the topic tags for the generated prompt(s) and the received response(s)). If the LLM generates a new survey prompt, the method 100 loops back to block 104, at which the user is prompted for another verbatim response. Otherwise, the method 100 terminates at block 126.

In various embodiments, the method 100 further includes determining whether one or more relevant resources were obtained from the LLM at block 128. In particular, the LLM may be utilized to generate one or more resource tags corresponding to the verbatim response received from the user, where such resource tag(s) relate to one or more resources (e.g., help or support solutions) that may be of interest to the user in solving one or more issues that were indicated by the user's verbatim response. Additionally or alternatively, in some embodiments, one or more resources may be obtained from a dedicated help platform (e.g., a platform including help information and/or links to support articles, for example), and/or the user may be provided with an option to contact an application support team. Moreover, if any relevant resources are identified at block 128, the method 100 may terminate at block 130 with the surfacing of the resource(s) via the user interface.

Furthermore, in various embodiments, after the method 100 has terminated at block 108, 120, 126, or 130, the method 100 further includes aggregating the verbatim responses obtained from various survey instances across the application (in combination with the topic tag metadata generated by the LLM during such survey instances) and generating application insights for the corresponding application. In particular, such data may be fed into an insights tool, resulting in the generation of application insights relating to the collected feedback (e.g., typically in the form of an application insights report, dashboard, or the like). More specifically, the verbatim responses received from the users are first aggregated by grouping the responses according to the topic tags generated by the LLM. Additional insights analysis is then performed by leveraging clustering and/or topic modeling, such as, for example, LDA or HDBSCAN, to associate sub-topics with the responses. The generation of sub-topics may be utilized as a basis to provide a more refined, customized application insights report to the application service provider, enabling the application service provider to determine which aspects of the application would benefit from updates, for example. Moreover, additional text analytics and metrics may also be applied to the aggregated and/or clustered feedback to track the health and trends of the corresponding applications, and such information may also be included within the application insights report. For example, the application insights report may include information relating to the feedback volume, overall customer sentiment, overall text quality, and/or overall actionability score for the application.

The block diagram of FIG. 1 is not intended to indicate that the blocks of the method 100 are to be executed in any particular order, or that all of the blocks of the method 100 are to be included in every case. Moreover, any number of additional blocks may be included within the method 100, depending on the details of the specific implementation. For example, in various embodiments, the method 100 further includes storing the feedback data that are input by the user during the execution of the method 100. This may include storing the feedback data separately at each step or as a batch operation at the end of the method 100. Such data storage enables (among other things) the aggregation of the collected feedback data across multiple survey instances at block 132.

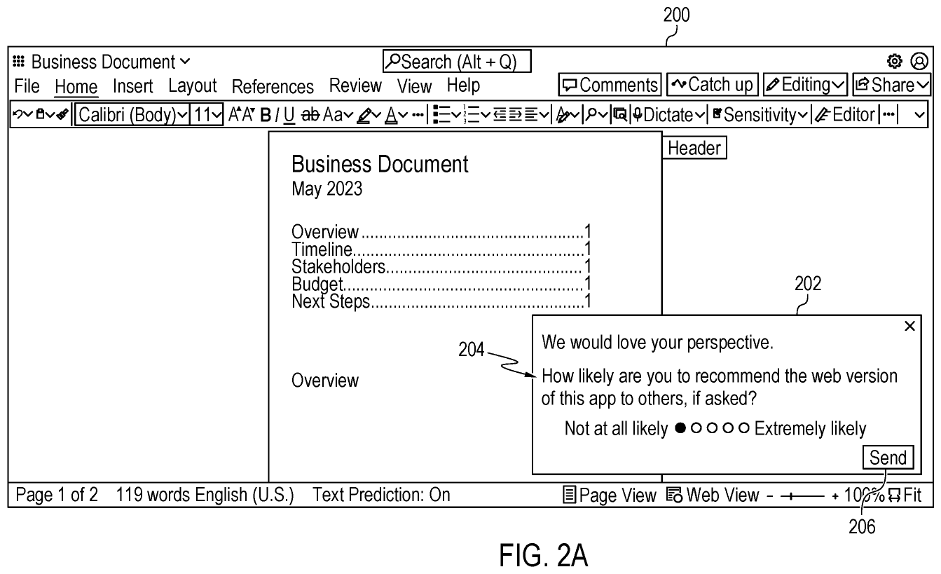

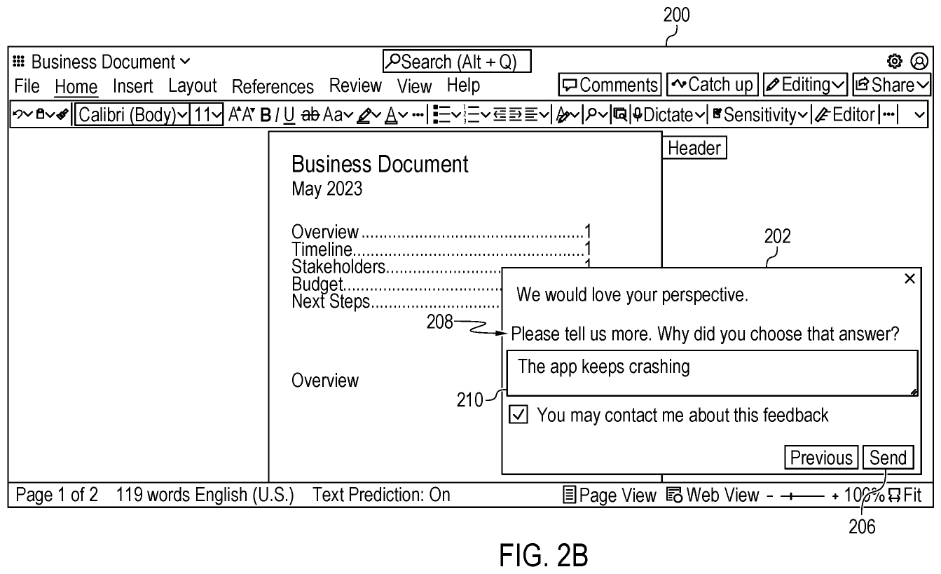

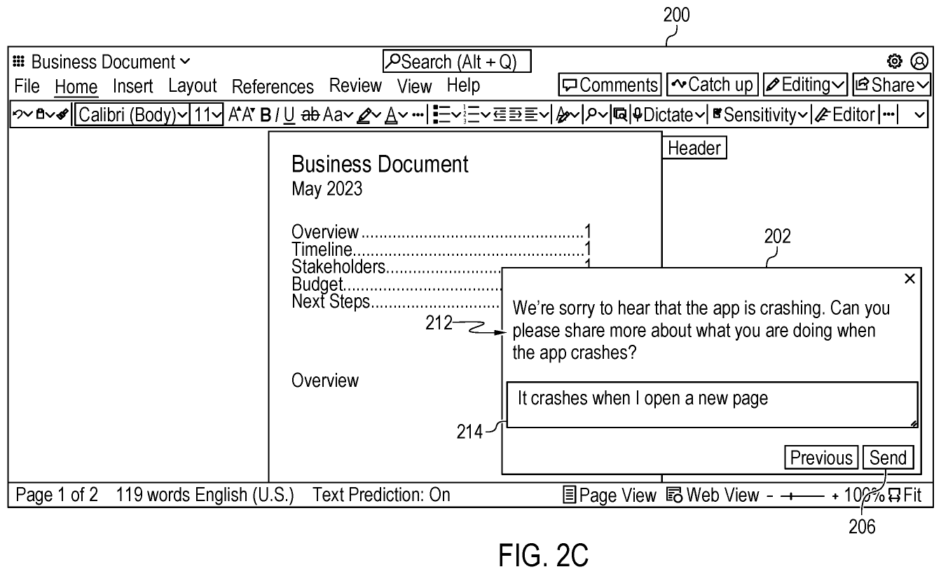

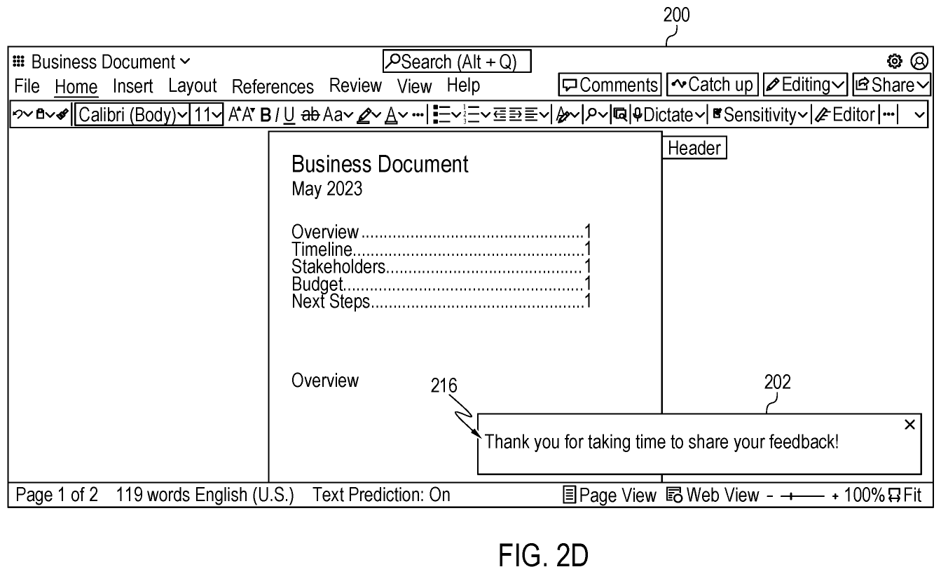

FIGS. 2A, 2B, 2C, and 2D are simplified schematic views of an exemplary user interface 200 for implementing at least a portion of the techniques described herein. The exemplary user interface 200 corresponds to an application and is surfaced on the display of a user computing system during the execution of such application, as described herein. Those skilled in the art will appreciate that such exemplary user interface 200 is for illustrative purposes only. In practice, the techniques described herein may be implemented using any other suitable type of user interface arranged or designed in any other suitable manner, depending on the details of the particular implementation.

As shown in FIG. 2A, the exemplary user interface 200 corresponds to a word processing application. During the utilization of such application, a survey user interface element 202 (e.g., a pop-up window or collapsible pane) is surfaced. According to the embodiment shown in FIG. 2A, the survey user interface element 202 includes a rating-based survey prompt 204 that states “How likely are you to recommend the web version of this app to others, if asked?” A rating system of 1 (“Not at all likely”) to 5 (“Extremely likely”) is then provided below the survey question, thus enabling the user to select a rating. In FIG. 2A, the user has selected a rating of 1, indicating that the user is not at all likely to recommend the web version of the application.

Turning to FIG. 2B, once the user selects a “Send” button 206 on the survey user interface element 202 (as shown in FIG. 2A), the survey user interface element 202 surfaces a survey prompt 208 including a text box 210 that enables the user to provide a free-text (or verbatim) response to the question “Please tell us more. Why did you choose that answer?” According to the embodiment shown in FIG. 2B, the user has input “The app keeps crashing.”

Now turning to FIG. 2C, once the user hits the “Send” button 206 again, the survey user interface element 202 surfaces another, more detailed survey prompt 212 that has been generated using an LLM, as provided by the present techniques. Because the LLM is provided with the user's previous responses and, optionally, other data corresponding to the user, the survey prompt 212 shown in FIG. 2C is specifically tailored to the user and is engineered to elicit a thorough, actionable verbatim response from the user. Specifically, according to embodiment shown in FIG. 2C, the survey prompt 212 states “We're sorry to hear that the app is crashing. Can you please share more about what you are doing when the app crashes?” This survey prompt 212 is accompanied by another text box 214 that enables the user to provide a verbatim response to the question. In the embodiment shown in FIG. 2C, the user inputs “It crashes when I open a new page” and then hits the “Send” button 206 again, resulting in the surfacing of a “Thank You” message 216 (e.g., “Thank you for taking time to share your feedback!”) on the survey user interface element 202, as shown in FIG. 2D.

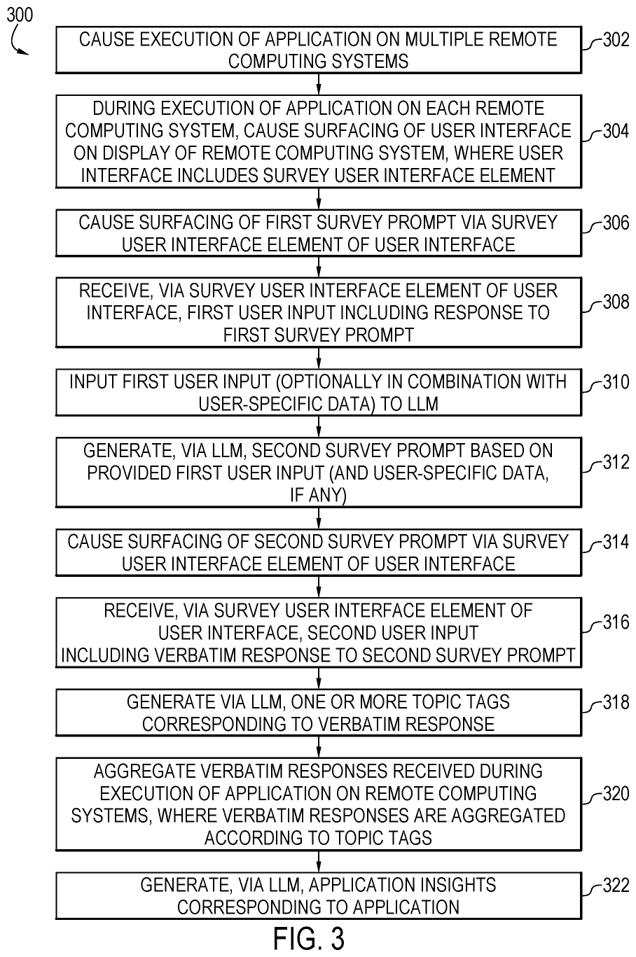

FIG. 3 is a process flow diagram of another exemplary method for obtaining actionable application feedback from users via LLM-based survey prompt generation and LLM-based application insights generation according to embodiments described herein. The method 300 is executed via one or more computing systems, such as the exemplary computing system described with respect to FIG. 4. In particular, in various embodiments, the computing system(s) implementing the method 300 include computing system(s) or server(s) that are run by an application service provider that provides for the execution of one or more applications on remote computing systems operated by users. The computing system(s)/server(s) include one or more processors and one or more computer-readable storage media including computer-executable instructions that, when executed by the processor(s), cause the processor(s) to perform the blocks of the method 300. An exemplary embodiment of such computer-readable storage media is described with respect to FIG. 6. Moreover, in various embodiments, the method 300 is executed within the context of a network environment including one or more application service provider computing system(s)/server(s), as described further with respect to the exemplary network environment of FIG. 5.

The method 300 begins at block 302, at which an application is caused to be executed on multiple remote computing systems. Blocks 304-318 are then performed during the execution of the application on each of the remote computing systems (or at least some portion thereof). Turning to block 304, a user interface is caused to be surfaced on a display of the remote computing system, where the user interface includes a survey user interface element, as described with respect to FIG. 2, for example. At block 306, a first survey prompt is caused to be surfaced via the survey user interface element of the user interface. The first survey prompt may be provided in the form of a rating-based prompt or a verbatim prompt, depending on the details of the particular implementation.

At block 308, a first user input including a response to the first survey prompt is received via the survey user interface element of the user interface. In various embodiments, the received response is classified (via the LLM) to determine whether the response constitutes noise or another type of feedback for which follow-up is not indicated, and the method 300 is terminated if the response does constitute noise or another type of feedback for which follow-up is not indicated.

At block 310, the first user input (and, optionally, user-specific data) are input to an LLM, such as, for example, a generative pre-trained transformer model. At block 312, a second survey prompt is generated via the LLM based on the provided first user input (and the user-specific data, if any was provided). At block 314, the second survey prompt is caused to be surfaced via the survey user interface element of the user interface.

At block 316, a second user input including a verbatim response to the second survey prompt is received via the survey user interface element of the user interface. At block 318, one or more topic tags corresponding to the verbatim response are generated via the LLM. In some embodiments, this is performed via prompt engineering. In such embodiments, the survey prompt itself contains instructions and examples for generating the topic tags based on the verbatim response. In other embodiments, this is performed via model fine tuning. In such embodiments, a generative LLM may be trained to process the verbatim response and to generate a follow-up response including one or more topic tags for the verbatim response (or both the verbatim response and the survey prompt combined). Moreover, in some embodiments, the method 300 includes generating, via the LLM, one or more resource tags corresponding to the verbatim response received from at least one of the remote computing systems, where the resource tag indicates one or more resources that are responsive to the verbatim response, as well as causing surfacing of the resource(s) via the display of the at least one of the remote computing systems.

Turning now to blocks 320 and 322, the feedback data collected from all the remote computing systems are combined and collectively analyzed and utilized. Specifically, at block 320, the verbatim responses received during the execution of the application on the remote computing systems are aggregated according to the topic tag(s) corresponding to each verbatim response. At block 322, application insights corresponding to the application are generated via the LLM based (at least in part) on the aggregated verbatim responses from block 320, where such application insights include one or more metrics relating to application performance, application usage, subscription value, and/or user satisfaction with respect to the application. In various embodiments, this also includes performing clustering and/or topic modeling to associate one or more sub-topic tags with each verbatim response (or at least a portion thereof), and the sub-topic tags may then be used to further aggregate the verbatim responses according to more detailed topics or themes. Moreover, in various embodiments, the method 300 also includes causing surfacing of an application insights report including the generated application insights via the display of at least one of the remote computing systems. Furthermore, in some embodiments, the method 300 also includes generating, via the LLM, an actionability score corresponding to each verbatim response, aggregating the actionability scores to generate an overall actionability score for the verbatim responses corresponding to the application, and incorporating the overall actionability score into the application insights.

The block diagram of FIG. 3 is not intended to indicate that the blocks of the method 300 are to be executed in any particular order, or that all of the blocks of the method 300 are to be included in every case. Moreover, any number of additional blocks may be included within the method 300, depending on the details of the specific implementation. For example, in various embodiments, any number of additional survey prompts may be generated via the LLM, depending on whether the verbatim response for the previous survey prompt is determined to be responsive enough (e.g., as determined via the actionability score or another measure of actionability). Therefore, blocks 310-318 of the method 300 may effectively operate as a loop, in which the latest verbatim response from the user is input to the LLM, and the LLM is utilized to determine whether to generate another survey prompt.

FIG. 4 is a block diagram of an exemplary computing system 400 for implementing the techniques described herein. The exemplary computing system 400 includes a processor 402 and a memory 404. The processor 402 may include any suitable type of processing unit or device, such as, for example, a single-core processor, a multi-core processor, a computing cluster, or any number of other configurations. Moreover, the processor 402 may include, for example, an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combinations thereof, designed to perform the functions described herein.

The memory 404 typically (but not always) includes both volatile memory 406 and non-volatile memory 408. The volatile memory 406 retains or stores information so long as the memory is supplied with power. By contrast, the non-volatile memory 408 is capable of storing (or persisting) information even when a power supply is not available. The volatile memory 406 may include, for example, RAM (e.g., synchronous RAM (SRAM), dynamic RAM (DRAM), synchronous dynamic RAM (SDRAM), and the like) and CPU cache memory. The nonvolatile memory 408 may include, for example, read-only memory (ROM) (e.g., programmable ROM (PROM), electrically programmable ROM (EPROM), electrically erasable ROM (EEROM) or the like), flash memory, nonvolatile random-access memory (RAM), solid-state memory devices, memory storage devices, and/or memory cards.

The processor 402 and the memory 404, as well as other components of the computing system 400, are interconnected by way of a system bus 410. The system bus 410 can be implemented using any suitable bus architecture known to those skilled in the art.

According to the embodiment shown in FIG. 4, the computing system 400 also includes a disk storage 412. The disk storage 412 may include any suitable removable/non-removable, volatile/non-volatile storage component or device. For example, the disk storage 412 may include, but is not limited to, a magnetic disk drive, floppy disk drive, tape drive, Jaz drive, Zip drive, LS-210 drive, flash memory card, memory stick, or the like. In addition, the disk storage 412 may include storage media separately from (or in combination with) other storage media including, but not limited to, an optical disk drive, such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 412 to the system bus 410, a removable or non-removable interface is typically used, such as interface 414 shown in FIG. 4.

In various embodiments, the disk storage 412 and/or the memory 404 function as one or more databases that are used to store data 416 relating to the techniques described herein. Such data 416 may include, but are not limited to, application feedback data (and accompanying metadata) obtained during the execution of one or more application(s) 418 on various remote computing systems 420 according to embodiments described herein.

Those skilled in the art will appreciate that FIG. 4 describes software that acts as an intermediary between a user of the computing system 400 and the basic computing resources described with respect to the operating environment of the computing system 400. Such software includes an operating system 422. The operating system 422, which may be stored on the disk storage 412, acts to control and allocate the computing resources of the computing system 400. Moreover, the application(s) 418, including one or more web-based applications 424 and/or one or more mobile applications 426, take advantage of the management of the computing resources by the operating system 422 through one or more program modules stored within a computer-readable storage medium (or media) 428, as described further herein. Furthermore, it should be noted that, according to embodiments described herein (and as depicted in FIG. 4), the operating system 422 may optionally be treated as one of the application(s) 418 for which actionable user feedback may be obtained, depending on the details of the particular implementation.

The computing system 400 also includes an input/output (I/O) subsystem 430. The I/O subsystem 430 includes a set of hardware, software, and/or firmware components that enable or facilitate inter-communication between the user of the computing system 400 and the processor 402 of the computing system 400. During operation of the computing system 400, the I/O subsystem 430 enables the user to interact with the computing system 400 through one or more I/O devices 432. Such I/O devices 432 may include any number of input devices or channels, such as, for example, one or more touchscreen/haptic input devices, one or more buttons, one or more pointing devices, one or more accessories, one or more audio input devices, and/or one or more video input devices, such as a camera. Furthermore, in some embodiments the one or more input devices or channels connect to the processor 402 through the system bus 410 via one or more interface ports (not shown) integrated within the I/O subsystem 430. Such interface ports may include, for example, a serial port, a parallel port, a game port, and/or a universal serial bus (USB).

In addition, such I/O devices 432 may include any number of output devices or channels, such as, for example, one or more audio output devices, one or more haptic feedback devices, and/or one or more display devices. Such output devices or channels may use some of the same types of ports as the input devices or channels. Thus, for example, a USB port may be used to both provide input to the computing system 400 and to output information from the computing system 400 to a corresponding output device. Moreover, in some embodiments, the one or more output devices or channels are accessible via one or more adapters (not shown) integrated within the I/O subsystem 430.

In various embodiments, the computing system 400 is communicably coupled to any number of remote computing systems 420. The remote computing system(s) 420 may include, for example, one or more personal computers (e.g., desktop computers, laptop computers, or the like), one or more tablets, one or more mobile devices (e.g., mobile phones), one or more network PCs, and/or one or more workstations. As an example, in some embodiments, the computing system 400 is an application service provider server hosting the application(s) 418 in a networked environment using logical connections to the remote computing systems 420. In such embodiments, the computing system 400 provides for the execution of the application(s) 418 on the remote computing systems 420 with the enhanced functionality provided by the techniques described herein.

In various embodiments, the remote computing systems 420 are logically connected to the computing system 400 through a network 434 and then connected via a communication connection 436, which may be wireless. The network 434 encompasses wireless communication networks, such as local-area networks (LAN) and wide-area networks (WAN). LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL).

The communication connection 436 includes the hardware/software employed to connect the network 434 to the bus 410. While the communication connection 436 is shown for illustrative clarity as residing inside the computing system 400, it can also be external to the computing system 400. The hardware/software for connection to the network 434 may include, for example, internal and external technologies, such as mobile phone switches, modems including regular telephone grade modems, cable modems and DSL modems, ISDN adapters, and/or Ethernet cards.

As described above, the system applications, such as the application(s) 418, take advantage of the management of the computing resources by the operating system 422 through one or more program modules stored within the computer-readable storage medium (or media) 428. In some embodiments, the computer-readable storage medium 428 is integral to the computing system 400, in which case it may form part of the memory 404 and/or the disk storage 412. In other embodiments, the computer-readable storage medium 428 is an external device that is connected to the computing system 400 when in use.

In various embodiments, the one or more program modules stored within the computer-readable storage medium 428 include program instructions or code that may be executed by the processor 402 to perform various operations. In various embodiments, such program module(s) include, but are not limited to, an actionable application feedback module 438 that causes the processor 402 to perform the techniques described herein, as described with respect to the method 100 of FIG. 1 and/or the method 300 of FIG. 3, for example. Moreover, in some embodiments, the actionable application feedback module 438 may be broken down into one or more sub-modules, such as, for example, an LLM-based survey prompt generation sub-module 440 and an LLM-based application insights generation sub-module 442.

It is to be understood that the block diagram of FIG. 4 is not intended to indicate that the computing system 400 is to include all of the components shown in FIG. 4. Rather, the computing system 400 can include fewer or additional components not illustrated in FIG. 4 (e.g., additional applications, additional modules, additional memory devices, additional network interfaces, etc.). Furthermore, any of the functionalities of the one or more program modules/sub-modules may be partially, or entirely, implemented in hardware and/or in the processor 402. For example, the functionality may be implemented with an application specific integrated circuit, in logic implemented in the processor 402, or in any other device.

FIG. 5 is a block diagram of an exemplary network environment 500 for implementing the techniques described herein. As shown in FIG. 5, the network environment 500 includes one or more user computing systems 502 and one or more application service provider servers 504. Each user computing system 502 includes one or more processors 506 and memory 508 communicably coupled to the processor(s) 506. Each user computing system 502 may be implemented as any type of computing system, including (but not limited to) a personal computer, a laptop computer, a tablet computer, a portable digital assistant (PDA), a mobile phone (e.g., a smart phone), an electronic book (e-book) reader, a game console, a set-top box (STB), a smart television (TV), a portable game player, a portable media player, and so forth. FIG. 5 shows representative user computing systems in the forms of a desktop computer 502A, a laptop computer 502B, a tablet 502C, and a mobile device 502D. However, these are merely examples, and the user computing system(s) 502 described herein may take many other forms.

Each user computing system 502 may include one or more applications 510 (and/or data corresponding to the execution of such application(s) 510) and one or more computer-readable storage media 512 stored in the memory 508, as described with respect to the computing system 400 of FIG. 4, for example. Each user computing system 502 also includes a communication connection 514 by which the user computing system 502 is able to communicate with other devices, including the application service provider server(s) 504, over a network 516. Furthermore, each user computing system 502 includes a display 518, which may be a built-in display or an external display, depending on the particular type of computing system. According to embodiments described herein, the display 518 is configured to surface one or more user interfaces 520, including one or more user interfaces that provide surveying functionalities for obtaining actionable application feedback from users via LLM-based survey prompt generation and LLM-based application insights generation, as described herein.

In various embodiments, the application(s) 510 are implemented or hosted by the application service provider server(s) 504, which may be provided as one or more server farms or data centers, for example. As an example, in the embodiment shown in FIG. 5, the application service provider server(s) 504 include servers 504A-J, for example. Moreover, it should be noted that the server components shown in FIG. 5 may each be implemented within any or all of the multiple application service provider servers 504, depending on the details of the particular implementation. Specifically, the application service provider server(s) 504 include one or more processors 522 communicably coupled to memory 524. The memory 524 may include one or more multiple memory devices, depending on the details of the particular implementation. The application service provider server(s) 504 also include one or more communication connections 526 by which the application(s) 510 described herein may be executed or hosted on the user computing system(s) 502 via the network 516. In particular, the application service provider server(s) 504 provide for execution of the application(s) 510 on the user computing system(s) 502 by, for example, surfacing one or more user interfaces 520 associated with the application(s) 510 on the display 518 corresponding to each user computing system 502.

In various embodiments, the memory 524 includes the application(s) 510 described herein, as well as one or more computer-readable storage media 528. The computer-readable storage medium (or media) 528 includes program instructions or code that may be executed by the processor(s) 522 (and/or the processor(s) 506) to perform various operations. In various embodiments, such program module(s) include, but are not limited to, an actionable application feedback module 530 that causes the processor(s) 522 to perform operations in accordance with the techniques described herein, as described with respect to the method 100 of FIG. 1 and/or the method 300 of FIG. 3, for example. Moreover, in some embodiments, the actionable application feedback module 530 may be broken down into one or more sub-modules, such as, for example, an LLM-based survey prompt generation sub-module 532 and an LLM-based application insights generation sub-module 534. The memory 524 further includes a database 536, which may be configured to store (among other data) the application feedback data (and accompanying metadata) obtained during the execution of the application(s) 510 on the remote computing system(s) 502 according to embodiments described herein.

In some embodiments, at least a portion of the module 530 (and/or any of the sub-modules 532 and 534) may be stored within separate application service provider server(s) 504. However, those skilled in the art will appreciate that the techniques described herein are not limited to any particular configuration of the application service provider server(s) 504.

It is to be understood that the simplified block diagram of FIG. 5 is not intended to indicate that the network environment 500 is to include all of the components shown in FIG. 5. Rather, the network environment 500 may include different components and/or additional components not illustrated in FIG. 5. For example, in practice, the user computing system(s) 502 and the application service provider server(s) 504 will typically include a number of additional components not depicted in the simplified block diagram of FIG. 5, as described with respect to the computing system 400 of FIG. 4, for example.

FIG. 6 is a block diagram of an exemplary computer-readable storage medium (or media) 600 for implementing the techniques described herein. In various embodiments, the computer-readable storage medium 600 is accessed by one or more processor(s) 602 over one or more computer interconnects 604. For example, in some embodiments, the computer-readable storage medium 600 is the same as, or similar to, the computer-readable storage medium described with respect to the computing system 400 of FIG. 4 and/or the network environment 500 of FIG. 5.

In various embodiments, the computer-readable storage medium 600 includes code (i.e., computer-executable instructions) to direct the processor(s) 602 to perform the operations of the present techniques. Such code may be stored within the computer-readable storage medium 600 in the form of program modules, where each module includes a set of computer-executable instructions that, when executed by the processor(s) 602, cause the processor(s) 602 to perform a corresponding set of operations. In particular, as described herein, the computer-readable storage medium 600 includes an actionable application feedback module 606 (as well as corresponding LLM-based survey prompt generation and LLM-based application insights generation sub-modules 608 and 610, respectively) that direct the processor(s) 602 to perform the techniques described herein.

Moreover, those skilled in the art will appreciate that any suitable number of the modules shown in FIG. 6 may be included within the computer-readable storage medium (or media) 600. Furthermore, any number of additional modules/sub-modules not shown in FIG. 6 may be included within the computer-readable storage medium (or media) 600, depending on the details of the specific implementation.

It should be noted that some components shown in the figures are described herein in the context of one or more structural components, referred to as functionalities, modules, features, elements, etc. However, the components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computing systems, discrete logic components, such as application specific integrated circuits (ASICs), and the like, as well as any combinations thereof.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, the terms “component,” “system,” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable storage medium.

Moreover, as used herein, the term “computer-readable storage medium (or media)” refers to an article of manufacture. In general, computer-readable storage media are used to host, store and/or reproduce computer-executable instructions and data for later retrieval and/or execution. When the computer-executable instructions that are hosted or stored on the computer-readable storage media are executed by a processor of a computing system, the execution thereof causes, configures and/or adapts the executing computing system to carry out various steps, processes, routines, methods and/or functionalities, including the steps, processes, routines, methods, and/or functionalities described herein. Examples of computer-readable storage media include, but are not limited to, optical storage media (such as Blu-ray discs, digital video discs (DVDs), compact discs (CDs), optical disc cartridges, and the like), magnetic storage media (such as hard disk drives, floppy disks, magnetic tape, and the like), memory storage devices (such as random access memory (RAM), read-only memory (ROM), memory cards, thumb drives, and the like), and cloud storage (such as online storage services). Computer-readable storage media may deliver computer-executable instructions to a computing system for execution via various transmission means and mediums, including carrier waves and/or propagated signals. However, for purposes of this disclosure, the term “computer-readable storage medium (or media)” refers specifically to non-transitory forms of computer-readable storage media and expressly excludes carrier waves and/or propagated signals.

The present techniques may be susceptible to various modifications and alternative forms, including (but not limited to) those described in the following examples:

Example 1 is a method for obtaining actionable application feedback, where the method is implemented via a computing system including a processor. The method includes: (a) causing execution of an application on multiple remote computing systems; (b) during the execution of the application on each of the remote computing systems: (1) causing surfacing of a user interface on a display of the remote computing system, where the user interface includes a survey user interface element; (2) causing surfacing of a first survey prompt via the survey user interface element of the user interface; (3) receiving, via the survey user interface element of the user interface, a first user input including a response to the first survey prompt; (4) inputting the first user input to a large language model (LLM); (5) generating, via the LLM, a second survey prompt based on the provided first user input; (6) causing surfacing of the second survey prompt via the survey user interface element of the user interface; (7) receiving, via the survey user interface element of the user interface, a second user input including a verbatim response to the second survey prompt; and (8) generating, via the LLM, at least one topic tag corresponding to the verbatim response; (c) aggregating the verbatim responses received during the execution of the application on all the remote computing systems, where the verbatim responses are aggregated according to the at least one topic tag corresponding to each verbatim response; and (d) generating, via the LLM, application insights corresponding to the application based on the aggregated verbatim responses, where the application insights include one or more metrics relating to application performance, application usage, subscription value, and/or user satisfaction with respect to the application.

Example 2 includes the method of example 1, including or excluding optional features. In this example, the method includes: inputting, in addition to the first user input, user-specific data to the LLM; and generating, via the LLM, the second survey prompt based on the provided first user input and the user-specific data.

Example 3 includes the method of example 1 or 2, including or excluding optional features. In this example, the method includes causing surfacing of an application insights report including the generated application insights via the display of at least one of the remote computing systems.

Example 4 includes the method of any one of examples 1 to 3, including or excluding optional features. In this example, the method includes generating, via the LLM, the application insights corresponding to the application by performing at least one of clustering or topic modeling to associate at least one sub-topic tag with each verbatim response.

Example 5 includes the method of any one of examples 1 to 4, including or excluding optional features. In this example, the method includes: generating, via the LLM, a resource tag corresponding to the verbatim response received from at least one of the remote computing systems, where the resource tag indicates at least one resource that is responsive to the verbatim response; and causing surfacing of the at least one resource via the display of the at least one of the remote computing systems.

Example 6 includes the method of any one of examples 1 to 5, including or excluding optional features. In this example, the method includes: generating, via the LLM, an actionability score corresponding to each verbatim response; aggregating the actionability scores to generate an overall actionability score for the verbatim responses corresponding to the application; and incorporating the overall actionability score into the application insights.

Example 7 is an application service provider server. The application service provider server includes a processor, an application, a communication connection for connecting remote computing systems to the application service provider server via a network, and a computer-readable storage medium operatively coupled to the processor. The computer-readable storage medium includes computer-executable instructions that, when executed by the processor, cause the processor to: (a) cause execution of the application on the remote computing systems; (b) during the execution of the application on each of the remote computing systems: (1) cause surfacing of a user interface on a display of the remote computing system, where the user interface includes a survey user interface element; (2) cause surfacing of a first survey prompt via the survey user interface element of the user interface; (3) receive, via the survey user interface element of the user interface, a first user input including a response to the first survey prompt; (4) input the first user input to an LLM; (5) generate, via the LLM, a second survey prompt based on the provided first user input; (6) cause surfacing of the second survey prompt via the survey user interface element of the user interface; (7) receive, via the survey user interface element of the user interface, a second user input including a verbatim response to the second survey prompt; and (8) generate, via the LLM, at least one topic tag corresponding to the verbatim response; (c) aggregate the verbatim responses received during the execution of the application on all the remote computing systems, where the verbatim responses are aggregated according to the at least one topic tag corresponding to each verbatim response; and (d) generate, via the LLM, application insights corresponding to the application based on the aggregated verbatim responses, where the application insights include one or more metrics relating to application performance, application usage, subscription value, and/or user satisfaction with respect to the application.

Example 8 includes the method of example 7, including or excluding optional features. In this example, the computer-executable instructions, when executed by the processor, cause the processor to: input, in addition to the first user input, user-specific data to the LLM; and generate, via the LLM, the second survey prompt based on the provided first user input and the user-specific data.

Example 9 includes the method of example 7 or 8, including or excluding optional features. In this example, the computer-executable instructions, when executed by the processor, cause the processor to cause surfacing of an application insights report including the generated application insights via the display of at least one of the remote computing systems.

Example 10 includes the method of any one of examples 7 to 9, including or excluding optional features. In this example, the computer-executable instructions, when executed by the processor, cause the processor to generate, via the LLM, the application insights corresponding to the application by performing at least one of clustering or topic modeling to associate at least one sub-topic tag with each verbatim response.

Example 11 includes the method of any one of examples 7 to 10, including or excluding optional features. In this example, the computer-executable instructions, when executed by the processor, cause the processor to perform the following for at least one of the remote computing systems: generate, via the LLM, a resource tag corresponding to the verbatim response received from at least one of the remote computing systems, where the resource tag indicates at least one resource that is responsive to the verbatim response; and cause surfacing of the at least one resource via the display of the at least one of the remote computing systems.

Example 12 includes the method of any one of examples 7 to 11, including or excluding optional features. In this example, the computer-executable instructions, when executed by the processor, cause the processor to: generate, via the LLM, an actionability score corresponding to each verbatim response; aggregate the actionability scores to generate an overall actionability score for the verbatim responses corresponding to the application; and incorporate the overall actionability score into the application insights.

Example 13 includes the method of any one of examples 7 to 12, including or excluding optional features. In this example, the computer-executable instructions, when executed by the processor, cause the processor to perform the following for at least one of the remote computing systems: prior to generating the second survey prompt via the LLM, classify the response to the first survey prompt to determine whether the response includes noise or another type of feedback for which follow-up is not indicated; and generate the second survey prompt for the remote computing only if the response does not include noise or another type of feedback for which follow-up is not indicated.

Example 14 includes the method of any one of examples 7 to 13, including or excluding optional features. In this example, the LLM includes a generative pre-trained transformer model.

Example 15 includes the method of any one of examples 7 to 14, including or excluding optional features. In this example, the computer-executable instructions, when executed by the processor, cause the processor to provide the first survey prompt in the form of a rating-based prompt or a verbatim prompt.

Example 16 is a computer-readable storage medium. The computer-readable storage medium includes computer-executable instructions that, when executed by a processor, cause the processor to: (a) cause execution of an application on multiple remote computing systems; (b) during the execution of the application on each of the remote computing systems: (1) cause surfacing of a user interface on a display of the remote computing system, where the user interface includes a survey user interface element; (2) cause surfacing of a first survey prompt via the survey user interface element of the user interface; (3) receive, via the survey user interface element of the user interface, a first user input including a response to the first survey prompt; (4) input the first user input and user-specific data to an LLM; (5) generate, via the LLM, a second survey prompt based on the provided first user input and the user-specific data; (6) cause surfacing of the second survey prompt via the survey user interface element of the user interface; (7) receive, via the survey user interface element of the user interface, a second user input including a verbatim response to the second survey prompt; and (8) generate, via the LLM, at least one topic tag corresponding to the verbatim response; (c) aggregate the verbatim responses received during the execution of the application on all the remote computing systems, where the verbatim responses are aggregated according to the at least one topic tag corresponding to each verbatim response; and (d) generate, via the LLM, application insights corresponding to the application based on the aggregated verbatim responses, where the application insights include one or more metrics relating to application performance, application usage, subscription value, and/or user satisfaction with respect to the application.

Example 17 includes the application service provider server of example 16, including or excluding optional features. In this example, the computer-executable instructions, when executed by the processor, cause the processor to generate, via the LLM, the application insights corresponding to the application by performing at least one of clustering or topic modeling to associate at least one sub-topic tag with each verbatim response.

Example 18 includes the application service provider server of example 16 or 17, including or excluding optional features. In this example, the computer-executable instructions, when executed by the processor, cause the processor to perform the following for at least one of the remote computing systems: generate, via the LLM, a resource tag corresponding to the verbatim response received from at least one of the remote computing systems, where the resource tag indicates at least one resource that is responsive to the verbatim response; and cause surfacing of the at least one resource via the display of the at least one of the remote computing systems.

Example 19 includes the application service provider server of any one of examples 16 to 18, including or excluding optional features. In this example, the computer-executable instructions, when executed by the processor, cause the processor to: generate, via the LLM, an actionability score corresponding to each verbatim response; aggregate the actionability scores to generate an overall actionability score for the verbatim responses corresponding to the application; and incorporate the overall actionability score into the application insights.

Example 20 includes the application service provider server of any one of examples 16 to 19, including or excluding optional features. In this example, the LLM includes a generative pre-trained transformer model.

It should be noted that, while the methods and processes described herein are generally expressed in regard to discrete steps, these steps should be viewed as being logical in nature and may or may not correspond to any specific actual and/or discrete steps of a given implementation. In addition, the order in which these steps are presented in the various methods and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

Of course, while the methods and processes described herein include various novel features of the disclosed subject matter, other steps (not listed) may also be carried out in the execution of the subject matter set forth in these methods and processes. Those skilled in the art will appreciate that the logical steps of these methods and processes may be combined together or split into additional steps. Steps of the above-described methods and processes may be carried out in parallel or in series. Often, but not exclusively, the functionality of a particular method or process is embodied in software (e.g., applications, system services, libraries, and the like) that is executed on one or more processors of computing systems. Additionally, in various embodiments, all or some of the various methods and processes may also be embodied in executable hardware modules including, but not limited to, system on chips (SoC's), codecs, specially designed processors and/or logic circuits, and the like, on a computing system.

As suggested above, each method or process described herein is typically embodied within computer-executable instruction (or code) modules including individual routines, functions, looping structures, selectors, and switches (such as if-then and if-then-else statements), assignments, arithmetic computations, and the like, that, in execution, configure a computing system to operate in accordance with the particular method or process. However, as suggested above, the exact implementation in executable statement of each of the methods or processes is based on various implementation configurations and decisions, including programming languages, compilers, target processors, operating environments, and the linking or binding operation. Those skilled in the art will readily appreciate that the logical steps identified in these methods and processes may be implemented in any number of ways and, thus, the logical descriptions set forth above are sufficiently enabling to achieve similar results.

While various novel aspects of the disclosed subject matter have been described, it should be appreciated that these aspects are exemplary and should not be construed as limiting. Variations and alterations to the various aspects may be made without departing from the scope of the disclosed subject matter.

In particular and in regard to the various functions performed by the above described components, devices, circuits, systems and the like, the terms used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for obtaining actionable application feedback, wherein the method is implemented via a computing system comprising a processor, and wherein the method comprises:
causing execution of an application on multiple remote computing systems;
during the execution of the application on each of the remote computing systems:
causing surfacing of a user interface on a display of the remote computing system, wherein the user interface comprises a survey user interface element;
causing surfacing of a first survey prompt via the survey user interface element of the user interface;
receiving, via the survey user interface element of the user interface, a first user input comprising a response to the first survey prompt;
inputting the first user input to a large language model (LLM);
generating, via the LLM, a second survey prompt based on the provided first user input;
causing surfacing of the second survey prompt via the survey user interface element of the user interface;
receiving, via the survey user interface element of the user interface, a second user input comprising a verbatim response to the second survey prompt; and
generating, via the LLM, at least one topic tag corresponding to the verbatim response;
aggregating the verbatim responses received during the execution of the application on all the remote computing systems, wherein the verbatim responses are aggregated according to the at least one topic tag corresponding to each verbatim response; and
generating, via the LLM, application insights corresponding to the application based on the aggregated verbatim responses, wherein the application insights comprise at least one metric relating to at least one of application performance, application usage, subscription value, or user satisfaction with respect to the application.

2. The method of claim 1, comprising:
inputting, in addition to the first user input, user-specific data to the LLM; and
generating, via the LLM, the second survey prompt based on the provided first user input and the user-specific data.

3. The method of claim 1, comprising causing surfacing of an application insights report comprising the generated application insights via the display of at least one of the remote computing systems.

4. The method of claim 1, comprising generating, via the LLM, the application insights corresponding to the application by performing at least one of clustering or topic modeling to associate at least one sub-topic tag with each verbatim response.

5. The method of claim 1, comprising:
generating, via the LLM, a resource tag corresponding to the verbatim response received from at least one of the remote computing systems, wherein the resource tag indicates at least one resource that is responsive to the verbatim response; and
causing surfacing of the at least one resource via the display of the at least one of the remote computing systems.

6. The method of claim 1, comprising:
generating, via the LLM, an actionability score corresponding to each verbatim response;
aggregating the actionability scores to generate an overall actionability score for the verbatim responses corresponding to the application; and
incorporating the overall actionability score into the application insights.

7. An application service provider server, comprising:
a processor;
an application;
a communication connection for connecting remote computing systems to the application service provider server via a network; and
a computer-readable storage medium operatively coupled to the processor, the computer-readable storage medium comprising computer-executable instructions that, when executed by the processor, cause the processor to:
cause execution of the application on the remote computing systems;
during the execution of the application on each of the remote computing systems:
cause surfacing of a user interface on a display of the remote computing system, wherein the user interface comprises a survey user interface element;
cause surfacing of a first survey prompt via the survey user interface element of the user interface;
receive, via the survey user interface element of the user interface, a first user input comprising a response to the first survey prompt;
input the first user input to a large language model (LLM);
generate, via the LLM, a second survey prompt based on the provided first user input;
cause surfacing of the second survey prompt via the survey user interface element of the user interface;
receive, via the survey user interface element of the user interface, a second user input comprising a verbatim response to the second survey prompt; and
generate, via the LLM, at least one topic tag corresponding to the verbatim response;
aggregate the verbatim responses received during the execution of the application on all the remote computing systems, wherein the verbatim responses are aggregated according to the at least one topic tag corresponding to each verbatim response; and
generate, via the LLM, application insights corresponding to the application based on the aggregated verbatim responses, wherein the application insights comprise at least one metric relating to at least one of application performance, application usage, subscription value, or user satisfaction with respect to the application.

8. The application service provider server of claim 7, wherein the computer-executable instructions, when executed by the processor, cause the processor to:
input, in addition to the first user input, user-specific data to the LLM; and
generate, via the LLM, the second survey prompt based on the provided first user input and the user-specific data.

9. The application service provider server of claim 7, wherein the computer-executable instructions, when executed by the processor, cause the processor to cause surfacing of an application insights report comprising the generated application insights via the display of at least one of the remote computing systems.

10. The application service provider server of claim 7, wherein the computer-executable instructions, when executed by the processor, cause the processor to generate, via the LLM, the application insights corresponding to the application by performing at least one of clustering or topic modeling to associate at least one sub-topic tag with each verbatim response.

11. The application service provider server of claim 7, wherein the computer-executable instructions, when executed by the processor, cause the processor to perform the following for at least one of the remote computing systems:
generate, via the LLM, a resource tag corresponding to the verbatim response received from at least one of the remote computing systems, wherein the resource tag indicates at least one resource that is responsive to the verbatim response; and
cause surfacing of the at least one resource via the display of the at least one of the remote computing systems.

12. The application service provider server of claim 7, wherein the computer-executable instructions, when executed by the processor, cause the processor to:
generate, via the LLM, an actionability score corresponding to each verbatim response;
aggregate the actionability scores to generate an overall actionability score for the verbatim responses corresponding to the application; and
incorporate the overall actionability score into the application insights.

13. The application service provider server of claim 7, wherein the computer-executable instructions, when executed by the processor, cause the processor to perform the following for at least one of the remote computing systems:
prior to generating the second survey prompt via the LLM, classify the response to the first survey prompt to determine whether the response comprises noise or another type of feedback for which follow-up is not indicated; and
generate the second survey prompt for the remote computing only if the response does not comprise noise or another type of feedback for which follow-up is not indicated.

14. The application service provider server of claim 7, wherein the LLM comprises a generative pre-trained transformer model.

15. The application service provider server of claim 7, wherein the computer-executable instructions, when executed by the processor, cause the processor to provide the first survey prompt in the form of a rating-based prompt or a verbatim prompt.

16. A computer-readable storage medium comprising computer-executable instructions that, when executed by a processor, cause the processor to:
cause execution of an application on multiple remote computing systems;
during the execution of the application on each of the remote computing systems:
cause surfacing of a user interface on a display of the remote computing system, wherein the user interface comprises a survey user interface element;
cause surfacing of a first survey prompt via the survey user interface element of the user interface;
receive, via the survey user interface element of the user interface, a first user input comprising a response to the first survey prompt;
input the first user input and user-specific data to a large language model (LLM);
generate, via the LLM, a second survey prompt based on the provided first user input and the user-specific data;
cause surfacing of the second survey prompt via the survey user interface element of the user interface;
receive, via the survey user interface element of the user interface, a second user input comprising a verbatim response to the second survey prompt; and
generate, via the LLM, at least one topic tag corresponding to the verbatim response;
aggregate the verbatim responses received during the execution of the application on all the remote computing systems, wherein the verbatim responses are aggregated according to the at least one topic tag corresponding to each verbatim response; and
generate, via the LLM, application insights corresponding to the application based on the aggregated verbatim responses, wherein the application insights comprise at least one metric relating to at least one of application performance, application usage, subscription value, or user satisfaction with respect to the application.

17. The computer-readable storage medium of claim 16, wherein the computer-executable instructions, when executed by the processor, cause the processor to generate, via the LLM, the application insights corresponding to the application by performing at least one of clustering or topic modeling to associate at least one sub-topic tag with each verbatim response.

18. The computer-readable storage medium of claim 16, wherein the computer-executable instructions, when executed by the processor, cause the processor to perform the following for at least one of the remote computing systems:
generate, via the LLM, a resource tag corresponding to the verbatim response received from at least one of the remote computing systems, wherein the resource tag indicates at least one resource that is responsive to the verbatim response; and
cause surfacing of the at least one resource via the display of the at least one of the remote computing systems.

19. The computer-readable storage medium of claim 16, wherein the computer-executable instructions, when executed by the processor, cause the processor to:
generate, via the LLM, an actionability score corresponding to each verbatim response;
aggregate the actionability scores to generate an overall actionability score for the verbatim responses corresponding to the application; and
incorporate the overall actionability score into the application insights.

20. The computer-readable storage medium of claim 16, wherein the LLM comprises a generative pre-trained transformer model.
